(19) United States
(12) Patent Application Publication
(10) Pub. No.: US 2008/0119325 A1
(43) Pub. Date: May 22, 2008

(54) APPARATUS OF AN AUTOMATIC GEARBOX FOR GENERATING A STARTUP SIGNAL

(75) Inventors: Alfred Kolb, Friedrichshafen (DE); Gunther Horsak, Meckenbeuren (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/943,611

(22) Filed: Nov. 21, 2007

(30) Foreign Application Priority Data
Nov. 22, 2006 (DE) 10 2006 054 992.9

(51) Int. Cl. B60K 28/10; G06F 19/00

(52) U.S. Cl. 477/111; 701/53

(57) ABSTRACT

An apparatus of an automatic gearbox for generating a startup signal according to which starting of an engine, which interacts with the gearbox, is made possible or prevented. The apparatus having a position sensor (1) for detecting the position of a gearshift lever of the an automatic gearbox, and the position sensor (1) measuring distance and providing a measurement signal based on the distance measured. A transducer device (2) converts the measurement signal, from the position sensor, into a digital signal. A hardware circuit (5) generates a startup signal from the digital signal provided by the transducer device.

This application claims priority from German Application Serial No. 10 2006 054 992.9 filed Nov. 22, 2006.

### FIELD OF THE INVENTION

The present invention relates to an apparatus of an automatic gearbox for generating a startup signal, by means of which starting an engine that operates together with the gearbox can be locked or released.

### BACKGROUND OF THE INVENTION

Automatic gearboxes of motor vehicles have an apparatus for generating a startup signal, by means of which starting the engine is either prevented or made possible. Thus, starting the engine is only possible when a shift selector lever and/or gearshift lever of the gearbox is in the P (parking) or in the N (neutral) position, that is, when a non-positive gear and/or selector position of the automatic gearbox is selected via the shift selector lever. In order to monitor the selector position, numerous Hall sensors configured as position switches are built into prior art automatic gearboxes, a combination of such Hall sensors being assigned to each selector position of the automatic gearbox. The position switches configured as Hall sensors are connected to a hardware circuit of a gearbox control device, which decodes the measurement signals provided by the position switches and then generates a startup signal.

Thus, as described above, in prior art automatic gearboxes a combination of position switches configured as Hall sensors are assigned to each selector position, resulting in that each position switch has to be connected to the hardware circuit of the gearbox control device by means of wires. Due to the large quantity of wires, mounting is especially complex.

On this basis, it is the task of the present invention to provide an innovative apparatus of an automatic gearbox for generating a startup signal.

The apparatus according to the present invention comprises at least:
a position sensor for determining the position of a selector of an automatic gearbox, the position sensor carrying out a path measurement and providing a measurement signal;
a transducer device for converting the measurement signal of the position sensor into a digital signal; and
a hardware circuit that generates the startup signal from the digital signal provided by the transducer device.

### SUMMARY OF THE INVENTION

In terms of the present invention, the apparatus for generating the startup signal comprises a position sensor that detects distance measurements, the selector position of the automatic gearbox on the basis of the distance measurement. Thus, a combination of position switches is no longer provided for each selector position, but the position can in fact be detected with only one position sensor. This results in the reduction of a number of necessary wires, because only one position sensor has to be connected to the gearbox control device.

By using a position sensor of this type, the apparatus can subsequently be calibrated in the assembled state. Compared to the state of the art, the constructive design and assembly are simplified. Furthermore, it is possible to filter the generated startup signal in order to bypass short-term voltage drops of the supply voltage occurring, for example, during the starting procedure of an engine. This hardware filter can be deactivated via a software circuit.

The apparatus according to the present invention preferably further comprises a software circuit, that generates a further startup signal directly from the measurement signal of the position sensor parallel to the hardware circuit, the startup switch signal provided by the hardware circuit and the further startup signal provided by the software circuit being connected to one another via an OR-gate, and the output signal provided by the OR-gate acting as the actual startup signal, based on which starting of the engine, that interacts with the gearbox, is prevented or is possible.

### BRIEF DESCRIPTION OF THE DRAWINGS

Preferred further developments of the present invention are characterized by the subclaims and the following description. Exemplary embodiments of the present invention are explained in more detail, but not restricted by the drawing. In which:

FIG. 1 shows a block diagram of an apparatus of an automatic gearbox for generating a startup signal according to the present invention. Based on the startup signal generated by the apparatus according to the present invention, starting an engine, that interacts with the automatic gearbox, is prevented or made possible.

### DETAILED DESCRIPTION OF THE INVENTION

The apparatus according to the present invention has a position sensor 1, a selector position of the automatic gearbox being determined by ways of the position sensor 1 on the basis of a distance measurement. The position sensor 1, that performs the distance measurement, provides a measurement signal that is conveyed to a transducer unit 2, which converts the measurement signal provided by the position sensor 1 into a digital signal.

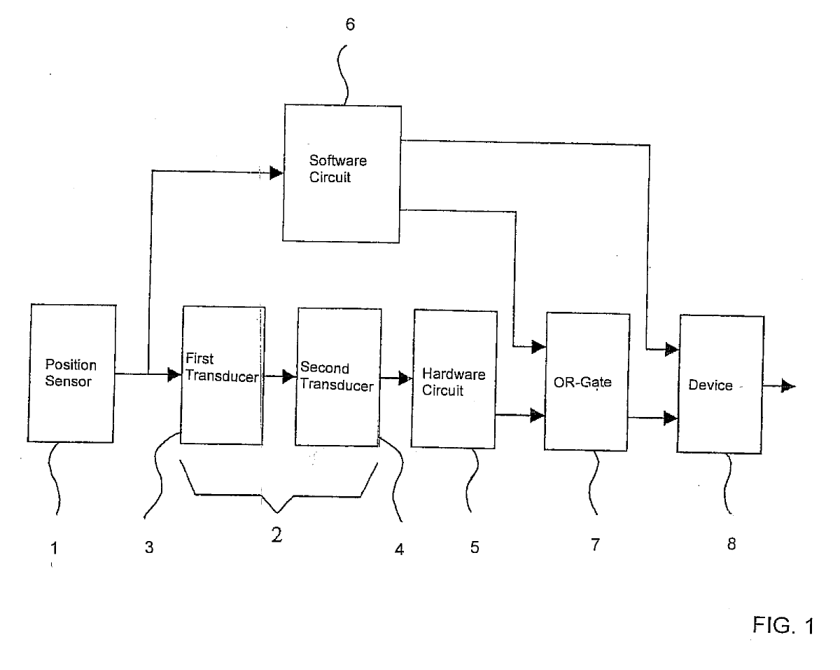

In the exemplary embodiment of the FIG. 1, the transducer unit 2 comprises two transducers, namely a first transducer 3 that converts a pulse width modulated measurement signal, provided by the position sensor 1, into an analog signal, and a second transducer 4 that converts the analog signal, provided by the first transducer 3, into the digital signal.

The measurement signal provided by the position sensor 1 can alternatively be a frequency modulated, pulse width modulated or logically encoded measurement signal, this measurement signal then being converted into an analog signal by the transducer 3. The position sensor 1 can also directly provide an analog measurement signal, as a result of which the first transducer 3 can then be dispensed with.

The digital signal provided by the transducer unit 2 is conveyed to a hardware circuit 5. The hardware circuit 5 then generates a first startup signal from the digital signal provided by the transducer unit 2.

According to the FIG. 1, the apparatus according to the present invention further has a software circuit 6 that generates a second further startup signal in parallel to the hardware circuit 5, namely directly form the pulse width modulated measurement signal provided by the position sensor 1.

The first startup signal provided by the hardware circuit 5 as well as the second startup signal provided by the software circuit 6 are connected to one another via an OR-gate 7, the output signal provided by the OR-gate 7 acting as an actual startup signal, based on which starting the engine, that interacts with the gearbox, is prevented or made possible.

The parallel generation of startup signals via the hardware circuit 5 as well as the software circuit 6 has the advantage that the hardware circuit 5 is able to provide an output signal even when the software circuit 6 is unable to provide an output signal due to a voltage drop upon starting the engine.

The hardware circuit 5 provides a respective output signal that corresponds to the first startup signal immediately after switching on the ignition of the motor vehicle, whereas the software circuit 6 has to be initialized first. In contrast, the software circuit 6 can evaluate the pulse width modulated output signal of the position sensor 1 more precisely, and thus provide a redundant output signal, which acts as a second startup signal.

In the exemplary embodiment of the FIG. 1, the apparatus according to the present invention further has a device 8, by way of which the output signal provided by the OR-gate 7 can be overwritten with the second output signal provided by the software circuit 6. The output signal provided by the OR-gate 7 is overwritten when the software circuit 6 detects that starting the engine that interacts with the automatic gearbox, is possible although the conditions for this enablement, that is, a non-positive selector position of the automatic gearbox, are no longer available.

This can be the case, for example, when the startup signal is extended by means of a filtering device in order to bypass voltage drops during the startup process. If the selector is moved from the P or N position, extending the process making the engine startup possible is not desired, so that in this case the software circuit 6 can immediately make the engine startup possible.

### REFERENCE NUMERALS

1 Position sensor
2 Transducer device
3 First Transducer
4 Second transducer
5 Hardware circuit
6 Software circuit
7 OR-gate
8 Device

1-4. (canceled)

5. An apparatus of an automatic gearbox for generating a startup signal, according to which starting an engine, which interacts with the automatic gearbox, is one of prevented and made possible, the apparatus comprising:
a position sensor (1) for determining a position of a selector lever of an automatic gearbox, the position sensor (1) measuring a path and providing a measurement signal based on the measured path;
a transducer device (2) for converting the measurement signal of the position sensor (1) into a digital signal; and
a hardware circuit (5) for generating the startup signal based on the digital signal provided by the transducer device (2).

6. The apparatus according to claim 5, wherein the transducer device (2) comprises a first transducer (3) and a second transducer (4), the first transducer (3) converting a pulse width modulated measurement signal of the position sensor (1) into an analog signal, and the second transducer (4) converting the analog signal provided by the first transducer (3) into the digital signal.

7. The apparatus according to claim 5, wherein a software circuit (6) is provided in parallel to the hardware circuit (5) and generates a further startup signal directly from the measurement signal of the position sensor (1), the startup signal provided by the hardware circuit (5) and the further startup switch signal provided by the software circuit (6) are united, via an OR-gate (7), into a combined startup signal, and based on the combined startup signal the engine is one of prevented from starting and enabled to start.

8. The apparatus according to claim 7, wherein a device (8) overwrites the combined startup signal, provided by the OR-circuit (7), with the further startup switch signal, provided by the software circuit (6), when the software circuit (6) detects that startup of the engine is enabled although conditions for enablement are not available.
